(19) United States
(12) Patent Application Publication
(10) Pub. No.: US 2015/0022721 A1
(43) Pub. Date: Jan. 22, 2015

(54) MULTI CONTENTS VIEW DISPLAY APPARATUS AND METHOD FOR DISPLAYING MULTI CONTENTS VIEW

(71) Applicant: SAMSUNG ELECTRONICS CO., LTD., Suwon-si (KR)

(72) Inventor: Pankaj AGARWAL, Suwon-si (KR)

(73) Assignee: SAMSUNG ELECTRONICS CO., LTD., Suwon-si (KR)

(21) Appl. No.: 14/323,084

(22) Filed: Jul. 3, 2014

(30) Foreign Application Priority Data
Jul. 16, 2013 (KR) 10-2013-0083477

(51) Int. Cl. H04N 5/445; H04N 21/422; H04N 21/431

(52) U.S. Cl. CPC H04N 5/44591; H04N 5/44582; H04N 21/4316; H04N 21/42204
USPC 348/564

(57) ABSTRACT

A multi contents view display method is provided, including performing signal-processing of first image information, displaying a first contents view using the signal-processed first image information, and displaying a second contents view using at least one from among the first image information and information related to the displayed first contents view.

### CROSS-REFERENCE TO RELATED APPLICATION

This application claims priority from Korean Patent Application No. 10-2013-0083477, filed on Jul. 16, 2013, in the Korean Intellectual Property Office, the disclosure of which is incorporated herein by reference in its entirety.

### BACKGROUND

1. Field

Apparatuses and methods consistent with exemplary embodiments relate to a multi-view system, and more particularly, to a multi contents view display apparatus capable of providing information regarding contents views watched by a plurality of users, and a multi contents view display method thereof.

2. Description of the Related Art

Multi-view systems that enable a plurality of users to watch different contents through a single display apparatus have been developed.

FIG. 1 is a diagram to describe the concept of a multi-view system. In the exemplary embodiment shown in FIG. 1, different contents, the first content 20, the second content 30, the third content 40, and the fourth content 50, are output by a single display apparatus 10. The system in which four (4) different contents are displayed and different users watch four (4) contents respectively at the same time is referred to as a quad-view system.

In the multi-view system, a stereoscopic method in which each content is watched using a glass apparatus that is matched with each content is well known. In the case of a 3-dimensional (3D) display apparatus, an autostereoscopic system in which viewing points vary according to viewing positions without the glass apparatus is being introduced.

For example, in a stereoscopic system, there is a shutter-glass type display apparatus. In the shutter glass type display apparatus, image frames of distinguishing contents such as the first content, the second content, etc are alternately displayed, and shutter glasses of glass apparatuses worn by users are alternately opened and closed in line with the displayed image frames so that a single user may watch only specific content.

For another example of the stereoscopic system, there is a display apparatus featuring a polarized method. In a polarized method system, image information of distinguishing contents such as the first content, the second content, etc is displayed on different areas of a single image frame, and images are output by differing the polarized properties according to each area. A glass apparatus blocks a predetermined polarized component so that the user may watch only specific content using the single glass apparatus.

The multi-view system has an advantage that each user may watch contents using a single display apparatus without disturbance by other users. However, in the multi-view system, a system manager needs to observe information regarding other contents. In particular, when the multi-view system is used in education, game, or medical field, there is a need for providing an authorized user with information regarding other contents.

### SUMMARY

Exemplary embodiments overcome the above disadvantages and other disadvantages not described above. Also, an exemplary embodiment may not be required to overcome the disadvantages described above, and an exemplary embodiment may not overcome any of the problems described above.

An exemplary embodiment provides a multi contents view display apparatus to provide an authorized user with information regarding other contents in a multi-view system, and a multi contents view display method thereof.

According to an aspect of an exemplary embodiment, a multi contents view display apparatus includes a signal processor configured to perform signal-processing of first image information, a display configured to display a first contents view using the signal-processed first image information, and a controller configured to output a second contents view using at least one from among the first image information and information related to the displayed first contents view.

The display may include a screen of the second contents view using the first image information.

The apparatus may further include a receiver configured to receive the first image information and the information related to the first contents view from an external device.

When a control command is received from a glass apparatus matched with the second contents view or from a remote controller which is the most adjacent to the glass apparatus, the controller may control display of the first contents view according to the received control command.

The first contents view and the second contents view may be displayed alternately according to a frame rate.

The first contents view may be displayed on a first area of a screen of a display apparatus, and the second contents view may be displayed on a second area of the screen of the display apparatus, and images displayed on the first area and the second area may have different polarized properties.

The signal processor may perform signal-processing of third image information and fourth image information, the display may display a third contents view and a fourth contents view using the signal-processed third image information and fourth image information, respectively, and the controller may display the second contents view using the first contents view, the third contents view, and the fourth contents.

According to another aspect of an exemplary embodiment, a multi contents view display method includes performing signal-processing of first image information, displaying a first contents view using the signal-processed first image information, and displaying a second contents view using at least one of the first image information and information related to the displayed first contents view.

In the operation of displaying the second contents view, a screen of the second contents view may be composed using the first image information.

The method may further include receiving the first image information and the information related to the first contents view from an external device.

The method may further include when a control command is received from a glass apparatus matched with the second contents view or from a remote controller which is the most adjacent to the glass apparatus, controlling display of the first contents view according to the received control command.

The first contents view and the second contents view may be displayed alternately according to a frame rate.

The first contents view may be displayed on a first area of a screen of a display apparatus, and the second contents view may be displayed on a second area of the screen of the display apparatus, and images displayed on the first area and the second area may have different polarized properties.

The method may further include performing signal-processing of third image information and fourth image information, and displaying a third contents view and a fourth contents view using the signal-processed third image information and fourth image information, respectively. In the operation of displaying the second contents view, the second contents view may be displayed using the first contents view, the third contents view, and the fourth contents view.

According to another exemplary embodiment, there is provided a multi contents view display method. The method comprises: performing signal-processing of a plurality of image information; displaying some of a plurality of contents views using some of the signal-processed plurality of image information; and displaying one of the plurality of contents views using at least one from among said some of the signal-processed plurality of image information and information related to the displayed some of the plurality of contents view.

A frame rate may correspond to a number of the displayed plurality of contents views. Also, in one exemplary embodiment, a user watching a specific contents view must have authorization to change to a different contents view.

According to yet another exemplary embodiment, there is provided a multi contents view display apparatus comprising: a signal processor configured to perform signal-processing of a plurality of image information; a display configured to display some of a plurality of contents views using some of the signal-processed plurality of image information; and a controller configured to output one of the plurality of contents views using at least one from among said some of the signal-processed plurality of image information and information related to the displayed some of the plurality of contents view.

According to the diverse exemplary embodiments, a multi view system provides a multi contents view display apparatus to provide an authorized user with information regarding other contents, and a multi contents view display method thereof.

Additional and/or other aspects and advantages of the invention will be set forth in part in the description which follows and, in part, will be obvious from the description, or may be learned by practice of the invention.

### BRIEF DESCRIPTION OF THE DRAWING FIGURES

The above and/or other aspects of the exemplary embodiments will be more apparent with reference to the accompanying drawings, in which:

FIG. 1 shows the concept of a multi-view system;

FIG. 2 shows an exemplary embodiment of a multi contents view display apparatus;

FIG. 3 is a block diagram of a configuration of a multi contents view display apparatus according to an exemplary embodiment;

FIG. 4 is a block diagram of a configuration of a multi contents view display apparatus according to another exemplary embodiment;

FIGS. 5 and 6 show scenarios according to diverse exemplary embodiments; and

FIGS. 7 to 10 are flowcharts of a multi contents view display method according to diverse exemplary embodiments.

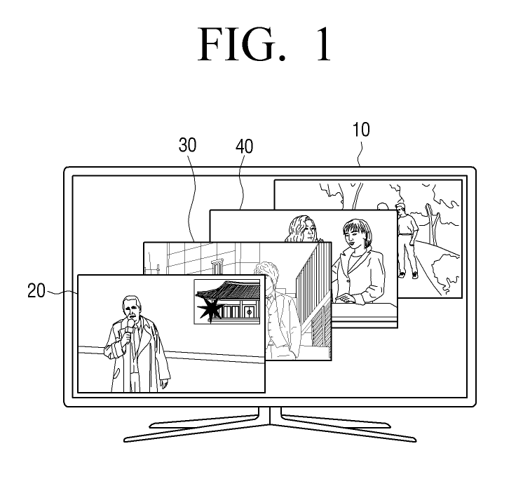

### DETAILED DESCRIPTION OF THE EXEMPLARY EMBODIMENTS

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

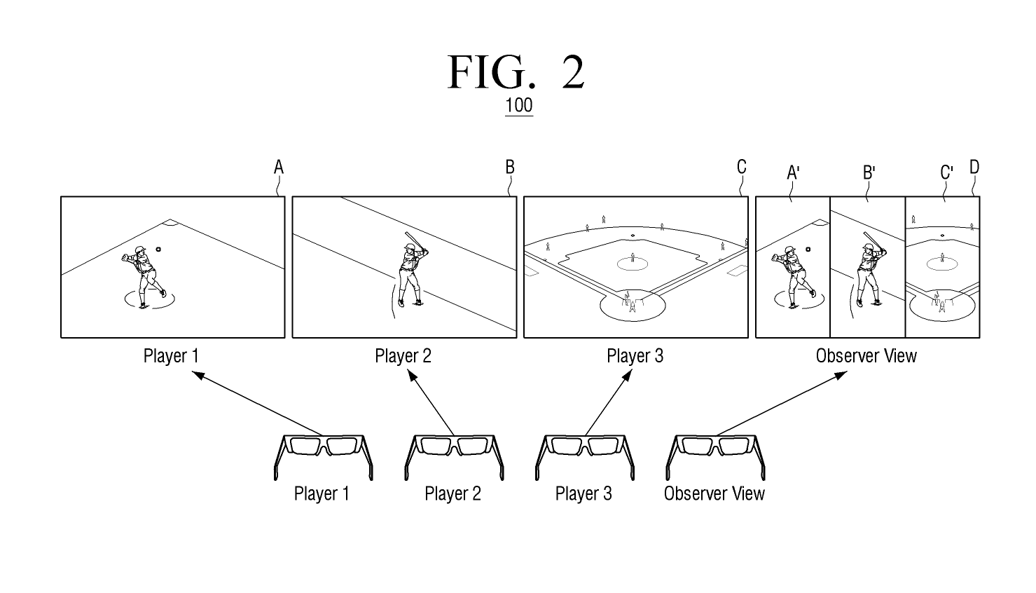

FIG. 2 shows an exemplary embodiment of a multi contents view display apparatus according to an exemplary embodiment of the present invention.

In FIG. 2, a plurality of users are playing a multi-player game. Each user watches a single contents view displaying his or her game screen.

The contents view indicates a display screen shown by a glass apparatus and sound synchronized with the display screen when a user watches one of a plurality of contents output by a display apparatus using the glass apparatus. Strictly speaking, the contents view is a concept including sound, but in the present application, the contents view focuses on the display screen for convenience of description.

In addition, the contents include pre-produced contents such as video-on-demand (VoD) contents, premium VoD contents, broadcast contents, internet contents, local files, and external contents connected over a digital living network alliance (DLNA) network. However, the contents are not limited thereto, but may also include recorded broadcast contents and real-time broadcast contents.

Each user may watch only his or her game screen using the worn glass apparatus and cannot watch other user's game screens. However, in order to provide services such as education, medical care, and game, another user needs to be authorized to watch at least one of the contents views. In this case, an observer view may be set to provide at least one contents view or information regarding the contents views. A screen of the observer view may be composed using information regarding the contents views. As shown in FIG. 2, the observer view displays a screen generated using at least one of image information of contents view 1 (A), contents view 2 (B), and contents view 3 (C) and information related to all of the contents views.

A configuration and operation of the multi contents view display apparatus 100 is described below.

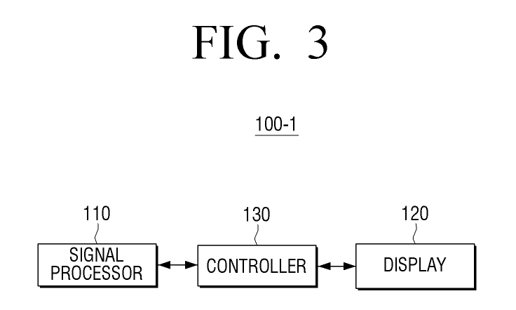

FIG. 3 is a block diagram of a configuration of a multi contents view display apparatus 100-1 according to an exemplary embodiment.

With reference to FIG. 3, the multi contents view display apparatus 100-1 may include a signal processor 110, a display 120, and a controller 130.

In this application, the multi contents view display apparatus 100-1 may include one or more displays and is a device composed to execute applications or display contents. For example, the multi contents view display apparatus 100-1 may be implemented with at least one of a digital television (TV), a tablet personal computer (PC), a portable multimedia player (PMP), a personal digital assistant (PDA), a smart phone, a mobile phone, a digital picture frame, a digital signage, and a kiosk.

The signal processor 110 performs signal-processing of video information and audio information that compose contents. The signal processor 110 receives a stream signal, and divides the stream signal into a video signal, an audio signal, and a data signal by demultiplexing. When the demultiplexed video signal is an encoded video signal, the signal processor 110 decodes the encoded video signal using a decoder. For example, an encoded video signal of MPEG-2 standard may be decoded by an MPEG-2 decoder, and a video signal of digital multimedia broadcasting (DMB) or H.264 standard of DVB-H may be decoded by an H.264 decoder. In addition, the signal processor 110 may adjust the brightness, tint, tone, etc of the video signal.

In addition, the signal processor 110 may process the demultiplexed audio signal. For example, an encoded audio signal of MPEG-2 standard may be decoded by an MPEG-2 decoder, and an encoded audio signal of MPEG 4 bit sliced arithmetic coding (BSAC) standard of terrestrial DMB may be decoded by an MPEG-4 decoder. In addition, an encoded audio signal of MPEG-2 advanced audio codec (AAC) standard of DMB or DVB-H method may be decoded by an AAC decoder. In addition, the signal processor 110 may adjust the base, treble, volume, etc.

Furthermore, the signal processor 110 performs data-processing of the demultiplexed data signal. The encoded data may be decoded. The encoded data may include an electronic program guide (EPG) indicating information regarding programs broadcasted on each channel. The EPG may include ATSC-program and system information protocol (TSC-PSIP) information in the case of ATSC method, or may include DVB-service information (DVB-SI) in the case of DVB method.

Information regarding the content views may be received as encoded data from an external device such as a broadcasting station server. The encoded data may be decoded and be displayed on one of the content views.

In the multi-view system, the single signal processor 110 may perform signal-processing of each content alternately or sequentially. However, if a high-performance processor or high power may be supplied, a plurality of signal processors 110 may perform signal-processing of each content in parallel.

In the case of a quad view, video information regarding 4 contents, the first video information, the second video information, the third video information and fourth video information, are signal-processed so that the first contents view, the second contents view, the third contents view and the fourth contents view may be generated and displayed.

The display 120 displays an image using the signal-processed video signal. The display 120 may include a scaler (not shown), a frame rate convertor (not shown), and a video enhancer (not shown). The scaler adjusts a picture ratio of an image. The video enhancer removes degradation or noise of an image, and stores the processed image data in a frame buffer. The frame rate convertor adjusts a frame rate, and transmits the image data of the frame buffer to a display module according to the set frame rate.

The display module is a circuit that outputs an image on a display panel (not shown), including a timing controller (not shown), a gate driver (not shown), a data driver (not shown), and a voltage driver (not shown).

The timing controller (not shown) generates a gate control signal (scanning control signal) and a data control signal (data signal), rearranges input R, G, and B data, and transmits the R, G, and B data to the data driver (not shown). The gate driver (not shown) applies to the display panel a gate on/off voltage (Vgh/Vgl) provided from the voltage driver according to the gate control signal generated by the timing controller. The data driver (not shown) completes scaling according to the data control signal generated by the timing controller, and inputs the RGB data of the image frame to the display panel. The voltage driver (not shown) generates driving voltages and transmits the driving voltages to the gate driver, the data driver, and the display panel.

The multi contents view display apparatus 100-1 according to an exemplary embodiment displays a plurality of contents views.

When the multi contents view display apparatus 100-1 is implemented in the shutter glass method, image frames that compose each of the plurality of contents view are alternately output from the frame buffer in a set frame rate and are provided to the display module. In this case, the frame rate is converted according to the number of the contents views. For example, when it is assumed that the frame rate is 60 Hz in a single view mode to display a single content, the frame rate is increased to 120 Hz in a dual view mode to display two different contents so that image frames included in each contents are alternately displayed during the same time. The frame rate in a quad view mode becomes 4 times larger than that in the single view mode.

However, when the multi contents view display apparatus 100-1 is implemented in the polarized method, a polarizer and a retarder film are attached onto a surface of the display panel. The polarizer blocks a polarized component of a predetermined direction, and the retarder film converts linear polarization into circular polarization (or changes properties of the circular polarization). According to areas of the display panel, the polarizer and the retarder film are arranged to have different properties. Accordingly, images displayed according to the areas of the display panel have different polarization properties. In this case, the multi contents view display apparatus 100-1 displays different contents according to the areas of the display panel, and the single glass apparatus views only an image having polarization of predetermined properties so that the single glass apparatus may match with distinguishing contents view.

The aforementioned display panel may be designed in diverse technologies. In other words, the display panel may be implemented with any one of organic light emitting diode (OLED), a liquid crystal display (LCD) panel, a plasma display panel (PDP), a vacuum fluorescent display (VFD), a field emission display (FED), and an electro luminescence display (ELD). In addition, the display panel may generally be a luminescent display, but does not exclude reflective displays (e-ink, P-ink, and photonic crystal). Furthermore, the display panel may be implemented with a flexible display or a transparent display. The display 110 may include a driving circuit to drive the display panel.

The controller 130 controls the overall operation of the multi contents view display apparatus 100-1. The controller 130 may generate and output an image on one of the plurality of contents views using image information regarding another contents view. For example, when a plurality of users are playing a game, each user may watch a contents view displaying a screen corresponding to a viewing point of his or her character using his or her glass apparatus. At this time, a game manager also needs to observe a game situation through a contents view. For the contents view matched with a glass apparatus worn by the game manager, the controller 130 may control the signal processor 110 and the display 120 to compose an image frame using image information regarding other contents views.

In addition, the controller 130 may control one of the plurality of contents views to output an image generated using the information regarding other contents views. In the aforementioned exemplary embodiment regarding the game, the game manager needs to watch the users' game records, and information regarding game items. The controller 130 may control the signal processor 110 and the display 120 to compose an image frame for the contents view matched with the game manager's glass apparatus using image information related to other contents views, and display the composed image frame through the matched contents view.

The controller 130 includes hardware components such as a micro processing unit (MPU) or a central processing unit (CPU), a cache memory, and a data bus, and software components such as an operating system, and an application to perform a specific purpose. Control commands for each component to operate the multi contents view display apparatus 100-1 is read by a memory according to a system clock, and the controller 130 generates an electrical signal and operates each component of the hardware according to the read control commands.

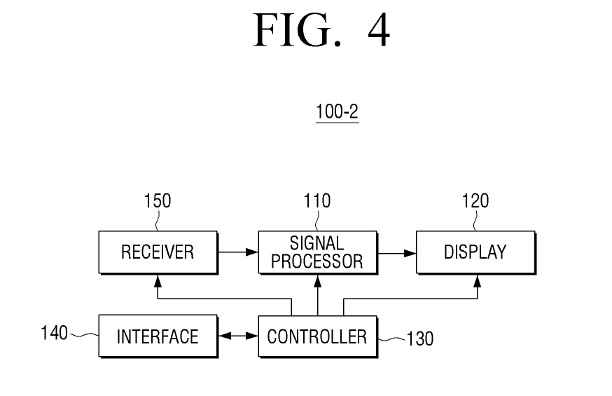

FIG. 4 is a block diagram of a configuration of a multi contents view display apparatus 100-2 according to another exemplary embodiment.

With reference to FIG. 4, the multi contents view display apparatus 100-2 may include a receiver 150, a signal processor 110, a display 120, a controller 130, and an interface 140. Operation of the components except for what is additionally described below is the same as that in the aforementioned exemplary embodiment.

The receiver 150 receives contents and information regarding the contents from an external device. The receiver 150 may receive broadcast program contents from a broadcasting station over a broadcast network, and receive contents from a web server over the internet. In addition, the receiver 150 may receive contents from diverse recording medium players that are provided in or are connected to the multi contents view display apparatus 100-2. The recording medium players indicate devices to play back contents stored in diverse types of recording media such as compact disks (CDs), digital video disks (DVDs), hard disks, Blu-ray disks, memory cards, and universal serial buses (USBs).

When the receiver 150 receives contents from a broadcasting station, the receiver 150 may include a tuner (not shown) and a demodulator.

The tuner selects a radio frequency (RF) broadcast signal corresponding to a selected channel among RF broadcast signals received over an antenna, and converts the selected RF broadcast signal into an intermediate frequency (IF) signal or a baseband video or audio signal. When the selected RF broadcast signal is a digital broadcast signal, the tuner converts it with a digital IF signal, or when the selected RF broadcast signal is an analog broadcast signal, the tuner converts it with an analog baseband video or audio signal (CVBS SIF). The output signal is input to the aforementioned signal processor 110. The tuner may receive a single carrier RF broadcast signal according to advanced television system committee (ATSC) method or a multiple carrier RF broadcast signal according to digital video broadcasting (DVB) method.

The demodulator (not shown) receives and demodulates a digital IF signal converted by the tuner. When the digital IF signal output by the tuner is a signal of the ATSC method, the demodulator performs 8-vestigial side band (VSB) demodulation. When the digital IF signal output by the tuner is a signal of the DVB method, the demodulator performs coded orthogonal frequency division modulation (COFDMA) demodulation. In addition, the demodulator may perform channel decoding such as trellis decoding, deinterleaving, Reed-Solomon decoding, etc.

When channel decoding is performed, a stream signal (TS) is output. The stream signal is a signal generated by multiplexing a video signal, an audio signal, and a data signal. For example, a video signal of MPEG-2 standard and an audio signal of Dolby AC-3 standard may be multiplexed MPEG-2 TS. The stream signal output by the demodulator is input to the aforementioned signal processor 110.

Unlike the above situation, the receiver 150 may receive contents from an external server such as a web server. In this case, the receiver 150 may be implemented with a network interface card (not shown). In this case, the multi contents view display apparatus 100-2 and the web server conform with TCP/IP, which is a standard protocol for information transmission over the internet. TCP refers to regulations to divide transfer data by a predetermined unit and packing the data, and IP refers to regulations related to a technology for directly transmitting and receiving data.

The receiver 150 may receive contents from diverse external devices as well as the internet. To do so, the receiver 150 may include a composite video banking sync (CVBS) terminal, a component terminal, an S-video terminal (analog), a digital visual interface (DVI) terminal, a high definition multimedia interface (HDMI) terminal, an RGB terminal, a D-SUB terminal, an IEEE1394 terminal, an SPDIF terminal, a liquid HD terminal, and a USB terminal.

In addition, the receiver 150 may include diverse wireless communication modules. For example, the receiver 150 may include short distance communication modules such as a wireless fidelity (WIFI) module, a Bluetooth module, an infrared data association (IrDA) module, a near field communication (NFC) module, a Zigbee module, an radio frequency identification (RFID) module, and an ultra wideband (UWB) module. In addition, the receiver 150 may be implemented with a 3G mobile communication module such as wideband CDMA (WCDMA), high speed downlink packet access (HSDPA), high speed uplink packet access (HSUPA), and high speed packet access (HSPA), a 4G mobile communication module such as mobile WiMAX and WiBro, or a 4G long term evolution (LTE) module.

Furthermore, the receiver 150 may receive contents from a set-top box. The set-top box may support bidirectional communication to support an internet protocol television (IP TV).

The receiver 150 may include at least one of the aforementioned technical components, and may receive contents from a plurality of different modules, and the signal processor 110 may perform signal-processing of the contents received from the plurality of different modules and generate a multi contents view.

The interface 140 receives a user command.

To do so, the interface 140 may include at least one physical button or a touch panel. When the user presses a button or touches an object on the touch panel, a corresponding control command is generated so that the multi contents view display apparatus 100-2 operates according to the generated control command.

Alternatively, the interface 140 may include the aforementioned short distance communication module, and thus receive a control signal transmitted from a remote controller. The user generates a control command by pressing a button on the remote controller, and the interface 140 receives the control command and transmits the control command to the controller 130. When the remote controller includes a touch panel or a movement sensor, the user's touch or movement of the remote controller may generate a control command.

Although a plurality of glass apparatuses to watch multi contents views are provided, a plurality of remote controllers are not generally provided. Accordingly, when a control signal is received from the remote controller, it needs to be determined from which glass apparatus user the control signal is transmitted. In this case, when a control signal is received from the remote controller, the multi contents view display apparatus 100-2 may determine that the control signal is received from a glass apparatus which is most adjacent to the remote controller. The remote controller may determine proximity of the glass apparatuses by short distance communication with the glass apparatuses. For example, the most adjacent glass apparatus may be identified based on intensity of signals received from the glass apparatuses, and when the control signal is transmitted, identification information regarding the glass apparatus may also be transmitted.

The glass apparatus (not shown) to watch the multi contents view may include a remote controlling function. In other words, when a button on the glass apparatus is pressed or a touch pad on the glass apparatus is touched, a corresponding control command may be generated and be transmitted to the multi contents view display apparatus 100-2.

In order to recognize the user's gesture, the interface 140 may include a means for photographing the user's gesture. In other words, the multi contents view display apparatus 100-2 may include at least one camera, and generate an image by processing an optical signal sensed by the camera. The multi contents view display apparatus 100-2 recognizes the user's gesture by detecting a rate of change of the image over time, and converts the user's gesture into a control command.

Unlike the above, the receiver 150 may generate a corresponding control command by recognizing the user's voice.

Since the signal processor 110, the display 120, and the controller 130 are the same components as in the aforementioned exemplary embodiment, detailed description is not repeated.

Scenarios according to different exemplary embodiments are described below.

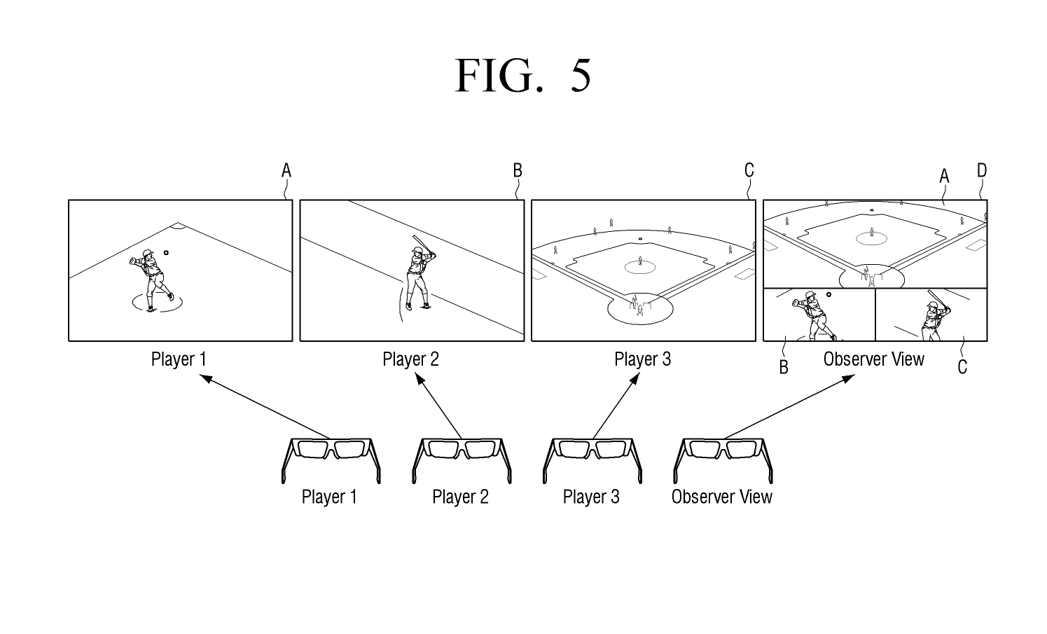

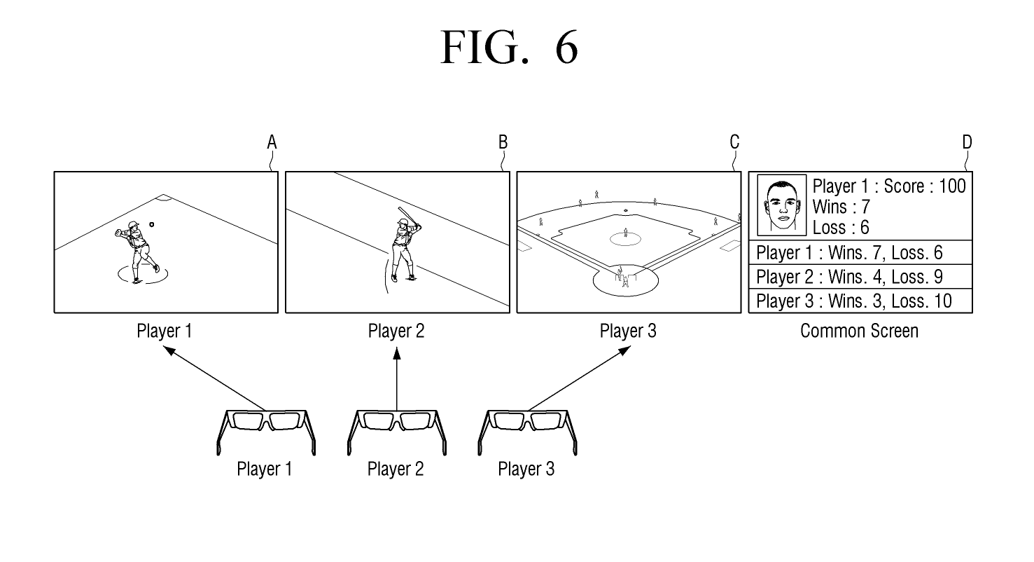

FIGS. 5 and 6 show scenarios according to different exemplary embodiments.

FIGS. 5 and 6 show multi contents view screens when a plurality of users are playing a baseball game. The first contents view (A) is a screen for player 1 to watch operation of a pitcher. The second contents view (B) is a screen for player 2 to watch operation of a hitter. The third contents view (C) is a screen for player 3 to set tactics of a coach and watching the entire game screen.

As shown in FIG. 5, a user who manages the game may determine the overall situation of the game through the fourth contents view (D). The screen of the fourth contents view (D) is composed using image information of the first contents view (A), the second contents view (B), and the third contents view (C).

Unlike the above exemplary embodiment, the screen of the fourth contents view (D) may be composed using information related to the first contents view (A), the second contents view (B), and the third contents view (C). FIG. 6 shows a screen illustrating each user' scores and information regarding game characters on the fourth contents view (D). In this case, the fourth contents view (D) may be a common screen. That is, when each user requests the fourth contents view (D), the fourth contents view (D) may be matched with each user's glass apparatus. In the case of a shutter glass type multi contents view display apparatus 100-2, the multi contents view display apparatus 100-2 generates a sync signal of the fourth contents view (D) and transmits the sync signal to the glass apparatus which requests the fourth contents view (D). The glass apparatus watches the fourth contents view (D) by turning on or off the shutter according to the received sync signal. In the case of a multi contents view display apparatus 100-2 of the polarized method, the multi contents view display apparatus 100-2 changes an image for an area on the display screen watched by the glass apparatus which requests the fourth contents view (D) into an image of the fourth contents view (D).

However, according to one exemplary embodiment, changing into other contents views except for the common contents may be prohibited in principle. For example, the viewer of the first contents view may request the third contents view, but the request may not allowed be allowed in principle, according to this exemplary embodiment. However, the request for other contents views may be allowed or prohibited according to specific service purposes such as education, medical care, and game.

A multi contents view display method according to different exemplary embodiments is described below.

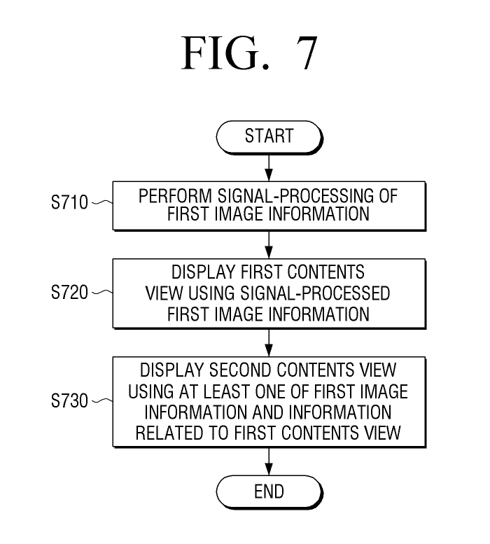

FIGS. 7 to 10 are flowcharts of a multi contents view display method according to different exemplary embodiments.

With reference to FIG. 7, a multi contents view display method according to an exemplary embodiment may include performing signal-processing of first image information (S710), displaying a first contents view using the signal-processed first image information (S720), and displaying a second contents view using at least one of the first image information and information related to the displayed first contents view (S730).

In the operation of displaying the second contents view (S730), a screen of the second contents view may be composed using the first image information.

In addition, the multi contents view display method may further include controlling display of the first contents view according to the received control command when a control command is received from a glass apparatus matched with the second contents view or from a remote controller which is the most adjacent to the glass apparatus.

In addition, the first contents view and the second contents view may be displayed alternately according to a frame rate.

The first contents view may be displayed on a first area of a screen of a display apparatus, and the second contents view may be displayed on a second area of the screen of the display apparatus, and images displayed on the first area and the second area may have different polarized properties.

The method may further include performing signal-processing of third image information and fourth image information, and displaying a third contents view and a fourth contents view using the signal-processed third image information and fourth image information, respectively. In the operation of displaying the second contents view (S730), the second contents view may be displayed using the first contents view, the third contents view, and the fourth contents.

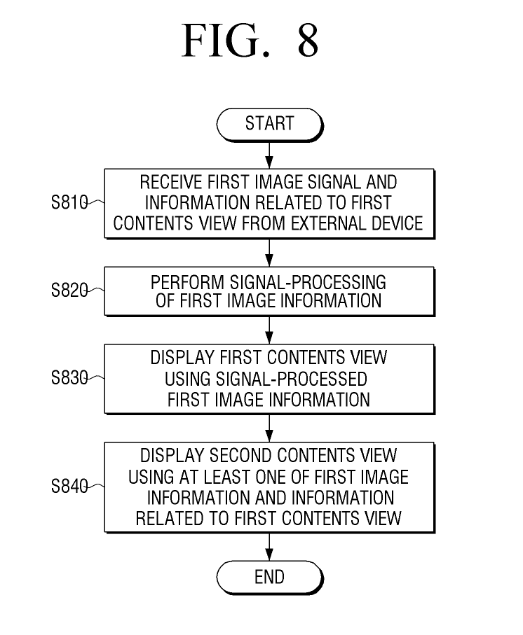

With reference to FIG. 8, a multi contents view display method according to another exemplary embodiment may include receiving a first image signal and information related to a first contents view from an external device (S810), performing signal-processing of first image information (S820), displaying a first contents view using the signal-processed first image information (S830), and displaying a second contents view using at least one of the first image information and information related to the displayed first contents view (S840).

Operations S820, S830, and S840 are the same as operations S710, S720, and S730.

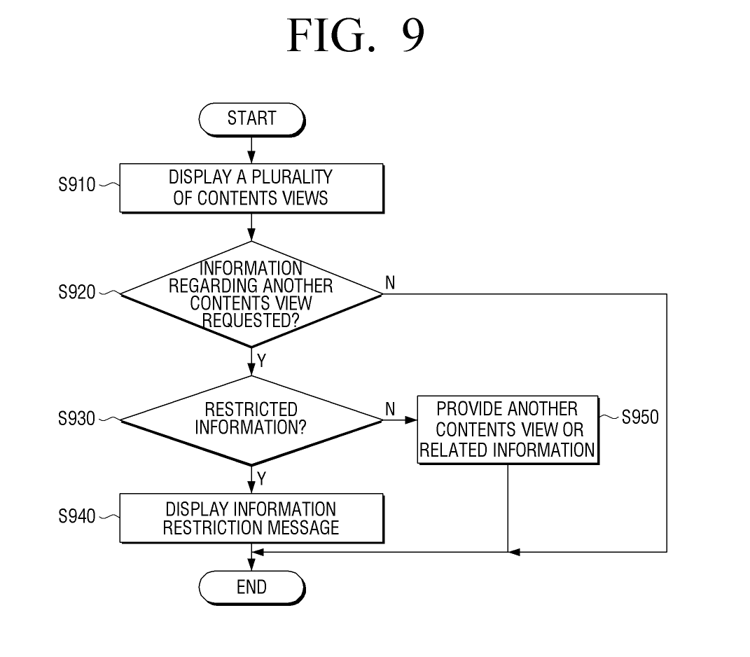

With reference to FIG. 9, a multi contents view display method according to yet another exemplary embodiment may include displaying a plurality of contents views (S910), and determining whether information regarding a requested contents view is restricted (S930) when information regarding another contents view is requested (S920-Y). When it is determined that the image information regarding the requested contents view is restricted due to inclusion of private information, an information restriction message may be displayed (S940). When it is determined that the image information regarding the requested contents view is allowable information, the requested contents view may be provided or information related to the requested contents view may be provided (S950).

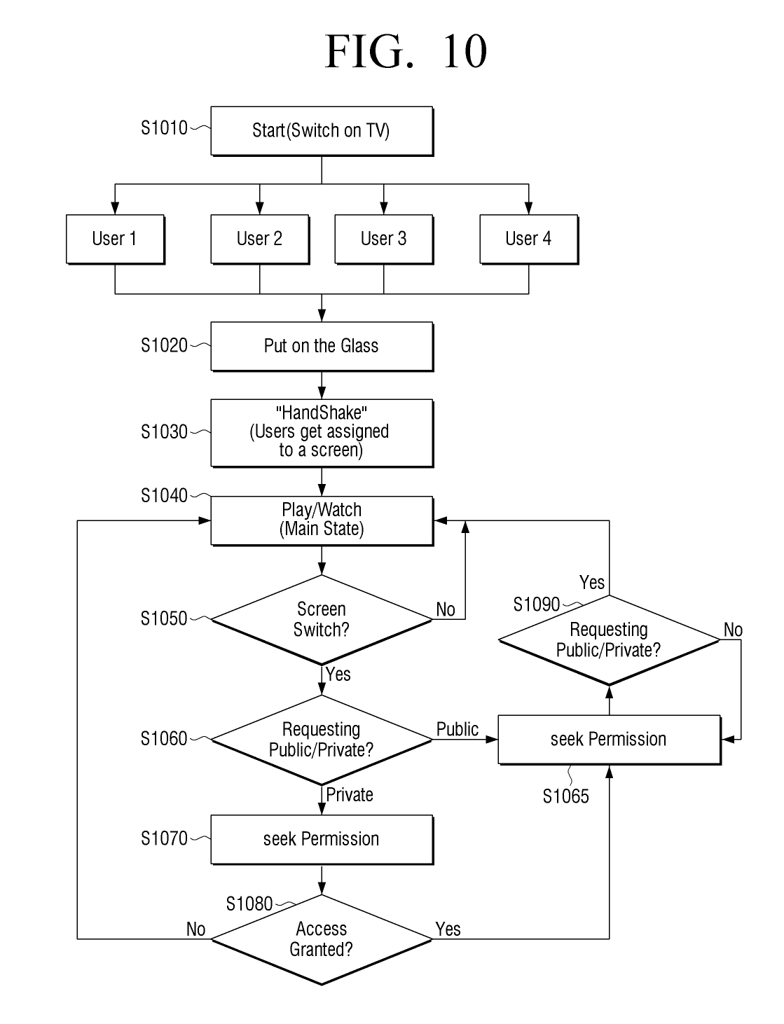

FIG. 10 shows a general multi contents view display method according to the exemplary embodiments.

When a display apparatus is turned on (S1010), each user puts on a glass apparatus (S1020). When the glass apparatus is turned on, the multi contents view display apparatus recognizes whether the glass apparatus is put on by receiving a put-on signal from the glass apparatus. The glass apparatus is paired with a predetermined contents view. The user who puts on the glass apparatus watches the predetermined contents view paired with the glass apparatus through the glass apparatus. At this time, as shown in FIG. 10, the user may transmit a contents view display command to the multi contents view display apparatus using the user's gesture (S1030). Each user watches contents displayed on each contents view paired with his or her glass apparatus (S1040).

A user watching a specific contents view may wish to switch to another contents view. It is possible to transmit a control command to the multi contents view display apparatus by manipulating his or her glass apparatus or by making a gesture which is similar to the aforementioned gesture. However, switching to another contents view is not always allowed. In other words, a public contents view which can be watched by many people and a private contents view including private information may be distinguished.

When another contents view to switch is a private contents view (S1060-PRIVATE), it is determined whether access to the contents view is permitted (S1070). When access to the contents view is granted (S1080-Y), the screen is switched into the contents view, but when access to the contents view is not granted (S1080-Y), the initial contents view is continuously shown.

The multi contents view display methods may be stored as a program in a non-transitory computer readable medium. The non-transitory computer readable medium is a medium which does not store data temporarily such as a register, cash, and memory but stores data semi-permanently and is readable by electronic devices. For example, the non-transitory computer readable medium may include compact disks (CDs), digital video disks (DVDs), hard disks, Blu-ray disks, universal serial buses (USBs), memory cards, and read-only memory (ROM).

Furthermore, the multi contents view display methods may be built in a hardware integrated circuit (IC) chip as embedded software, and be included as a component of the multi contents view display apparatus 100.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A multi contents view display method comprising:
performing signal-processing of first image information;
displaying a first contents view using the signal-processed first image information; and
displaying a second contents view using at least one from among the first image information and information related to the displayed first contents view.

2. The method as claimed in claim 1, wherein the operation of displaying the second contents view comprises composing a screen of the second contents view using the first image information.

3. The method as claimed in claim 1, further comprising:
receiving the first image information and the information related to the first contents view from an external device.

4. The method as claimed in claim 1, further comprising:
when a control command is received from a glass apparatus matched with the second contents view or from a remote controller which is most adjacent to the glass apparatus, controlling display of the first contents view according to the received control command.

5. The method as claimed in claim 1, wherein the first contents view and the second contents view are displayed alternately according to a frame rate.

6. The method as claimed in claim 1, wherein the first contents view is displayed on a first area of a screen of a display apparatus, and the second contents view is displayed on a second area of the screen of the display apparatus, and
images displayed on the first area and the second area have different polarized properties.

7. The method as claimed in claim 1, further comprising:
performing signal-processing of third image information and fourth image information; and
displaying a third contents view and a fourth contents view using the signal-processed third image information and fourth image information, respectively,
wherein in the operation of displaying the second contents view, the second contents view is displayed using the first contents view, the third contents view, and the fourth contents view.

8. A multi contents view display apparatus comprising:
a signal processor configured to perform signal-processing of first image information;
a display configured to display a first contents view using the signal-processed first image information; and
a controller configured to output a second contents view using at least one from among the first image information and information related to the displayed first contents view.

9. The apparatus as claimed in claim 8, wherein the display composes a screen of the second contents view using the first image information.

10. The apparatus as claimed in claim 8, further comprising:
a receiver configured to receive the first image information and the information related to the first contents view from an external device.

11. The apparatus as claimed in claim 8, wherein when a control command is received from a glass apparatus matched with the second contents view or from a remote controller which is most adjacent to the glass apparatus, the controller controls display of the first contents view according to the received control command.

12. The apparatus as claimed in claim 8, wherein the first contents view and the second contents view are displayed alternately according to a frame rate.

13. The apparatus as claimed in claim 8, wherein the first contents view is displayed on a first area of a screen of a display apparatus, and the second contents view is displayed on a second area of the screen of the display apparatus, and images displayed on the first area and the second area have different polarized properties.

14. The apparatus as claimed in claim 8, wherein the signal processor performs signal-processing of third image information and fourth image information,
the display displays a third contents view and a fourth contents view using the signal-processed third image information and fourth image information, respectively, and
the controller displays the second contents view using the first contents view, the third contents view, and the fourth contents view.
